(19) United States
(12) Patent Application Publication
(10) Pub. No.: US 2013/0262767 A1
(43) Pub. Date: Oct. 3, 2013

(54) Concurrently Accessed Set Associative Overflow Cache

(71) Applicant: FUTUREWEI TECHNOLOGIES, INC., Plano, TX (US)

(72) Inventors: Iulin Lih, San Jose, CA (US); Richard Trauben, Morgan Hill, CA (US)

(73) Assignee: Futurewei Technologies, Inc., Plano, TX (US)

(21) Appl. No.: 13/851,787

(22) Filed: Mar. 27, 2013

Related U.S. Application Data
(60) Provisional application No. 61/616,742, filed on Mar. 28, 2012.

(51) Int. Cl. G06F 12/08

(52) U.S. Cl. CPC G06F 12/0811
USPC 711/120

(57) ABSTRACT

An apparatus for concurrently accessing a primary cache and an overflow cache, comprising a core logic unit configured to perform a first instruction that accesses the primary cache and the overflow cache in parallel, determine whether the primary cache stores a requested data, determine whether the overflow cache stores the requested data, and access a main memory when the primary cache and the overflow cache do not store the requested data, wherein the overflow cache stores data that overflows from the primary cache.

### CROSS-REFERENCE TO RELATED APPLICATIONS

The present application claims priority to U.S. Provisional Patent Application No. 61/616,742 filed Mar. 28, 2012 by Yolin Lih, et al. and entitled “Concurrently Accessed Set Associative Victim Cache,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

For decades, improvements in semiconductor design and manufacturing have dramatically increased processor performance and main memory density. As clock speeds for processors increase and main memory becomes larger, longer latency periods may occur when a processor accesses main memory. Cache hierarchies (e.g. different cache levels) may be implemented to reduce latency and performance bottlenecks caused by frequent access to main memory. Cache may be one or more small high speed associative memories that reduce the average time to access main memory. To reduce the average time to access main memory, cache provides a copy of frequently referenced main memory locations. When a processor reads or writes a location in main memory, the processor first checks to see if a copy of the data already resides in the cache memory. When present, the processor is directed to the cache memory rather than the slower main memory.

For cache to be effective, a processor needs to continually access the cache rather than main memory. Unfortunately, the size of cache is typically smaller and limited to storing a smaller subset of the data within the main memory. The size limitation may inherently limit the “hit” rate within the cache. A “hit” occurs when the cache holds a valid copy of the data requested by the processor, while a “miss” occurs when the cache does not hold a valid copy of the requested data. When a “miss” occurs within the cache, the processor may subsequently access the slower main memory. Hence, frequent “misses” within a cache negatively impacts latency and processor performance. One method to reduce the “miss” rate is to increase the size of the cache and the amount of information stored within the cache. However, as the cache size increases and becomes more complex, cache performance (e.g. time required to access the cache) generally decreases. As a result, a design balance for the cache is typically struck between minimizing the “miss” rate and maximizing cache performance.

Victim cache may be implemented in conjunction with cache to minimize the impact of “misses” that occur within cache. For instance, when a cache replaces old data stored in the cache with new data, the cache may evict the old data and transfer the old data to the victim cache for storage. After the eviction of the old data, a “miss” may occur within the cache when the processor requests for the old data. The processor may subsequently access the victim cache to determine whether the old data is stored in the victim cache. Victim cache may be beneficial because accessing the victim cache instead of main memory reduces the time to reference missing data evicted from the cache. However, victim cache may be somewhat inflexible and limited in applicability. For example, the size of the victim cache is typically smaller and stores less information than the cache to avoid compromising the processor clock rate. Additionally, an increase in latency occurs when the processor accesses the victim cache subsequent to a “miss” within cache. In other words, the processor may wait at least one clock cycle before accessing the victim cache. Hence, a solution is needed to increase the flexibility and usability of the victim cache, and thereby increase processor performance.

### SUMMARY

In one embodiment, the disclosure includes an apparatus for accessing a primary cache and an overflow cache, comprising a core logic unit configured to perform a first instruction that accesses the primary cache and the overflow cache in parallel, determine whether the primary cache stores a requested data, determine whether the overflow cache stores the requested data, and access a main memory when the primary cache and the overflow cache do not store the requested data, wherein the overflow cache stores data that overflows from the primary cache.

In yet another embodiment, the disclosure includes an apparatus for concurrently accessing a primary cache and an overflow cache, comprising a primary cache that is divided into a plurality of primary cache blocks, an overflow cache that is divided into a plurality of overflow cache blocks, and a memory management unit (MMU) configured to perform memory management for the primary cache and the overflow cache, wherein the primary cache and the overflow cache are accessed within a same clock cycle.

In yet another embodiment, the disclosure includes a method for concurrently accessing a primary cache and an overflow cache, wherein the method comprises, determining whether a primary cache miss has occurred within a primary cache, determining whether an overflow cache miss has occurred within an overflow cache, selecting a primary cache entry using a first cache replacement policy when a primary cache miss has occurred within a primary cache, and selecting an overflow cache entry using a second cache replacement policy when an overflow cache miss has occurred within an overflow cache, wherein determining whether the primary cache miss and the overflow cache miss occurs within a same clock cycle.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a general-purpose computer system.

FIG. 2 is a schematic diagram of another embodiment of a general-purpose computer system that has different levels of cache embedded on a processing chip.

FIG. 3 is a schematic diagram of embodiment of a set associated mapping between main memory and the primary cache.

FIG. 4 is a schematic diagram of another embodiment of a set associated mapping between main memory and the primary cache.

FIG. 5 is a flowchart of an embodiment of a method to implement a write instruction to main memory using a write-through policy.

FIG. 6 is a flowchart of an embodiment of a method to implement a write instruction to main memory using a write-back policy.

FIG. 7 is a flowchart of an embodiment of a method to implement a read instruction to main memory using a write-through policy.

FIG. 8 is a flowchart of an embodiment of a method to implement a read instruction to main memory using a write-back policy.

FIG. 9 is a schematic diagram of embodiment of a memory subsystem that comprises a primary cache and overflow cache that share a MMU/translation table.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques described below, including the exemplary designs and implementations illustrated and described herein, but may be modified within the scope of the appended claims along with their full scope of equivalents.

Disclosed herein are a method, an apparatus, and a system to access an overflow cache concurrently with a primary cache. When a core logic unit (e.g. a processor) performs an application that accesses the primary cache, the core logic unit may also access the overflow cache in parallel and/or within the same clock cycle of the core logic unit. The primary cache may be configured as a M-way set associative, while the overflow cache may be configured as a N-way set associative, where M and N are integers. By concurrently accessing the primary cache and overflow cache, the core logic unit may be able to access a M+N-way set associative memory element. The overflow cache may be a separate memory element that may be configured to implement the same or different replacement policies than the primary cache. “Hits” within an overflow cache may be promoted to the primary cache to avoid evicting data to the main memory and/or to the remaining memory subsystem (e.g. next level of cache). In one embodiment, a single MMU may be used to perform memory management functions, such as an address translation and/or memory protection, for both the primary cache and overflow cache.

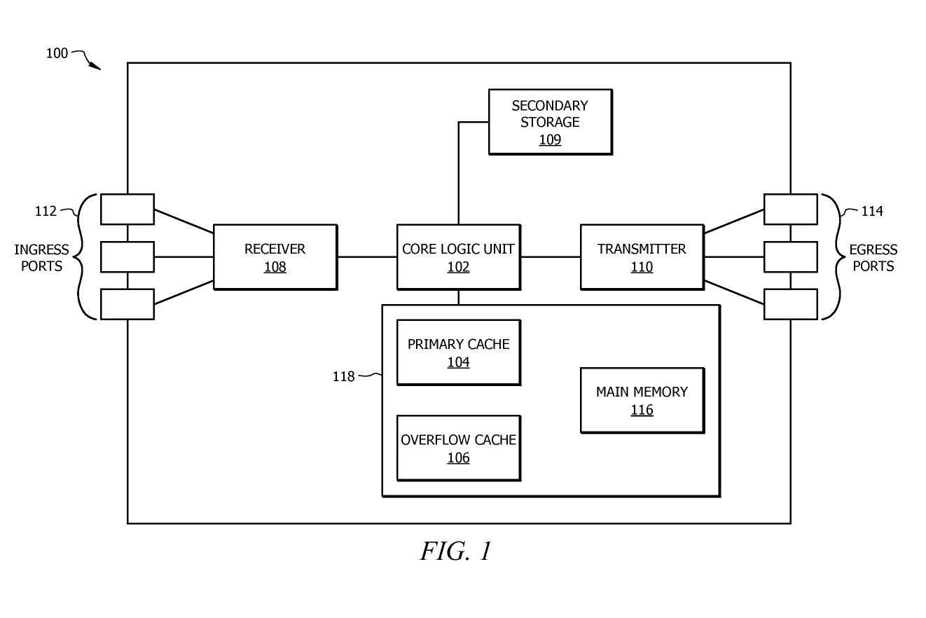

FIG. 1 is a schematic diagram of an embodiment of a general-purpose computer system 100. The general-purpose computer system 100 may be a computer or network component with sufficient processing power, memory resources, and network throughput capability to handle the necessary workload placed upon it, such as transporting and processing data through a network. In one embodiment, the general-purpose computer system 100 may be any network device, such as routers, switches, and/or bridges, used to transport data within a network. The general-purpose computer system 100 may comprise one or more ingress ports or units 112 and one or more egress ports or units 114. In one embodiment, the ingress ports or units 112 and egress ports or units 114 may be physical and/or logical ports. The ingress ports or units 112 may be coupled to a receiver (Rx) 108 for receiving signals and data from other network devices, while the egress ports and/or units 114 may be coupled to a transmitter (Tx) 110 for transmitting signals and data to the other network devices. The Rx 108 and Tx 110 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), other air interface protocol radio transceiver cards, and/or other well-known network devices.

The general-purpose computer system 100 may also comprise a core logic unit 102 coupled to the Rx 108 and the Tx 110, where the core logic unit 102 may be configured to implement any of the schemes described herein, such as accessing the primary cache 104, overflow cache 106, main memory 116, and other layers of memory subsystem 118. The core logic unit 102 may also be configured to implement methods 500, 600, 700, and 800 which will be described in more detail later. The core logic unit 102 may comprise one or more central processing unit (CPU) chips, field-programmable gate arrays (FPGAs), application specific integrated circuits (ASICs), and/or digital signal processors (DSPs), and/or may be part of one or more ASICs. In one embodiment, the core logic unit 102 may comprise one or more processors, where each processor is a multi-core processor.

FIG. 1 illustrates that the core logic unit 102 may be coupled to a secondary storage 109 and memory subsystem 118. The secondary storage 109 typically comprises one or more disk drives, tape drives, flash memory, and/or other non-volatile storage memory components. The secondary storage 109 may be configured as an overflow data storage device for when the memory subsystem 118 is not large enough to hold all the working data. The secondary storage 109 may be used to store programs that are loaded into the memory subsystem 118 when such programs are selected for execution. The memory subsystem 118 may be used to store volatile data and instructions for the core logic unit. In one embodiment, the memory subsystem 118 may comprise one or more Random Access Memory (RAM) memory components (e.g. static RAM (SRAM) and dynamic RAM (DRAM)). Access to the memory subsystem 118 is typically faster than to the secondary storage 109. The secondary storage 109, and/or memory subsystem 118 may be non-transitory computer readable mediums and may not include transitory, propagating signals. Any of the secondary storage 109 and/or memory subsystem 118 may be used to write and/or read (e.g. store and/or load) data. The core logic unit 102 may be configured to write and/or read data from the secondary storage 109 and/or memory subsystem 118.

The memory subsystem 118 may comprise a primary cache 104, an overflow cache 106, and main memory 116. The primary cache 104 may be a data cache that may be organized into one or more cache levels (e.g. level 1 (L1) cache and level 2 (L2) cache). The primary cache 104 may store the actual data fetched from the main memory 116. The primary cache 104 may typically be accessed faster and/or may have less storage capacity than the main memory 116. The primary cache 104 may be configured to store and/or load physical addresses or virtual addresses. For example, when core logic unit 102 is a single processor, the primary cache 104 may store virtual addresses. Alternatively, the primary cache 104 may store physical addresses when the core logic unit 102 is a multi-processor. Overflow cache 106 may be a separate memory element configured to store data evicted from the primary cache 104. The overflow cache 106 may act as overflow storage of data when the primary cache 104 is full and unable to store the data. The size of the overflow cache 106 and the configuration of the overflow cache 106 will be discussed in more detail below. As discussed above, the primary cache 104 and overflow cache 106 may be RAM memory components (e.g. SRAM).

The main memory 116 may be accessed after “misses” occur in the primary cache 104 and/or the overflow cache 106. In one embodiment, main memory 116 may be the next level of memory subsequent to the primary cache 104 and the overflow cache 106. The main memory 116 may have a larger capacity and may operate slower than both the primary cache and the overflow cache 106. A store queue (not shown in FIG. 1) may buffer main memory addresses and data designated for storage within the main memory 116. Prior to writing data into the main memory 116, the data may be first placed in the store queue. The store queue may prevent write-after-read and write-after-write dependencies errors. In one embodiment, the store queue may be a content-addressable-memory (CAM). Also, a load “miss” queue (not shown in FIG. 1) may buffer main memory addresses that missed during a load instruction within the primary cache 104 and the overflow cache 106 before reading from the main memory 116. The load “miss” queue may also buffer the data read from main memory 116 before storing the data read from main memory 116 to the primary cache 104.

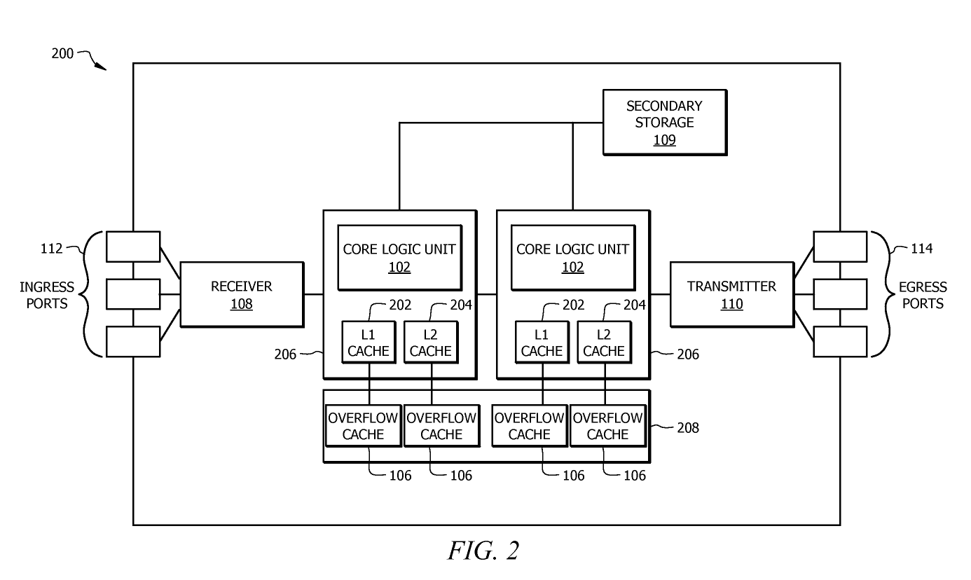

FIG. 2 is a schematic diagram of another embodiment of a general-purpose computer system 200 that has different levels of cache embedded on a processing chip. The general-purpose computer system 200 comprises two processing chips 206 that have on-chip cache. The processing chip 206 may be configured to house the core logic unit 102 and levels of the primary cache. More specifically, FIG. 2 illustrates that an L1 cache 202 and L2 cache 204 may be embedded on the same processing chip 206 as the core logic unit 102. The L1 cache 202 and L2 cache 204 may be different cache levels found within the primary cache 104. The core logic unit 102 may access the L1 cache 202 prior to accessing the L2 cache 204. In one embodiment, the L2 cache 204 may be larger than the L1 cache 202 and may be slower to access than the L1 cache 202. Other embodiments of processing chips 206 may include no embedded cache or have an embedded L1 cache 202 but no L2 cache 204 embedded within the processing chip 206. Persons or ordinary skill in the art are aware that other levels of cache may be embedded within the processing chip 206 (e.g. level 0 (L0) cache). Ingress ports and/or units 112, Rx 108, Tx 110, egress ports and/or units 114, and secondary storage 109 have been discussed above.

The memory subsystem 208 may be external to the processing chips 206 and may include portions of the memory subsystem 116 that was discussed in FIG. 1, but not embedded within the processing chips 206. Each of the processing chips 206 may be coupled to the memory subsystem 208, which may be configured to store volatile data. As shown in FIG. 2, the remaining memory subsystem 208 may comprise one or more overflow caches 106 used to store data evicted from different levels of cache. For example, one overflow cache 106 may be used to store evicted data from a L1 cache 202, while a second overflow cache 106 may be used to store evicted data from a L2 cache 204. Furthermore, each level of cache (e.g. L1 cache 202) embedded within different processing chips 206 may be allocated an overflow cache 106. For example, in FIG. 2, a L1 cache 202 embedded in the first processing chip 206 may be allocated an overflow cache 106, while the second L1 cache 202 embedded in the second processing chip 206 may be allocated to a different overflow cache 106. In one embodiment, some or all of the overflow caches 106 may be embedded within the processing chips 206. Additionally, the overflow caches 106 may be allocated to some of the level of caches and/or some of the processing chips 206. Persons of ordinary skill in the art are aware that the general-purpose computer system 200 may include more than two levels of caches (e.g. level 3 (L3) cache) not embedded within the processing chips 206, where each level of cache is allocated an overflow cache 106.

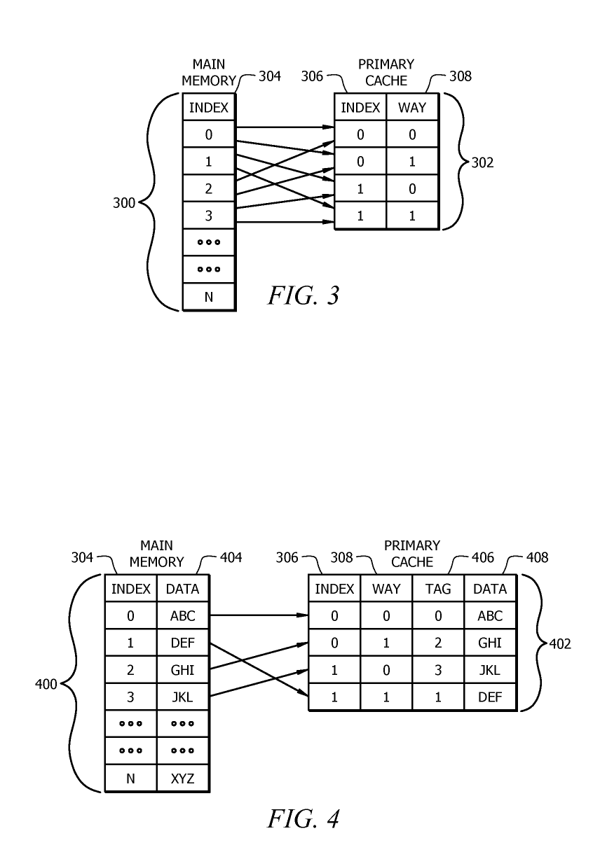

FIG. 3 is a schematic diagram of embodiment of a set associated mapping between main memory 300 and the primary cache 302. The main memory 300 and primary cache 302 may be substantially similar to the main memory 116 and primary cache 104 discussed in FIG. 1, respectively. The main memory 300 and primary cache 302 may be indexed with memory addresses that indicate the location of where the data is stored within the main memory 300 or the primary cache 302. “Index” column 304 may reference the index field for the address of the main memory 300 (e.g. address index 0 to N), while “index” column 306 references the index field for the address of the primary cache 302 (e.g. the cache row). As shown in FIG. 3, the primary cache 302 may have address index values of “0” and “1.” The “way” column 308 may determine the set associative for the primary cache 302 based on the number of different “way” values in “way” column 308. A set associative configuration may map each entry in main memory to more than one entry, but less than all of the entries, within the primary cache. The number of “way” values may indicate the number of address locations within the primary cache 302 that a particular address location in the main memory 300 may be cached in. FIG. 3 illustrates that the primary cache 302 may have two different “way” values of “0” and “1,” and thus the primary cache 302 may be designated as a two-way set associative. As a two-way set associative cache, main memory addresses may be mapped to two different address locations of the primary cache 302. As shown in FIG. 3, main memory 300 with address index of “0” may be mapped to the address index 0-way 0 and index 0-way 1 of the primary cache 302, main memory 300 with address index of “1” may be mapped to the address index 1-way 0 and index 1-way 1 of the primary cache 302, main memory 300 with address index of “2” may be mapped to the address index 0-way 0 and index 0-way 1 of the primary cache 302, and main memory 300 with address index of “3” may be mapped to the address index 1-way 0 and index 1-way 1 of the primary cache 302. In another embodiment, the primary cache 302 may be a M-way set associative (e.g. four-way set associative or eight-way set associative), where a particular main memory 300 location may be mapped to M different memory locations of the primary cache 302.

Other embodiments of the primary cache 302 may be a directly mapped cache or a fully associative cache. A directly mapped cache may map one memory location within main memory 300 to one memory location of the primary cache 302. In other words, a directly mapped cache may be a one-way set associative of the primary cache 302. A fully associative is when each entry in the main memory 300 may be mapped to any of the memory locations of the primary cache 302. Using FIG. 3 as an example, index address “0” may be mapped to the address index 0-way 0, address index 0-way 1, address index 1-way 0, address index 1-way 1, and any other memory location within the primary cache 302.

FIG. 4 is a schematic diagram of another embodiment of a set associated mapping between main memory 400 and the primary cache 402. The main memory 400 may be substantially similar to the main memory 300 as described in FIG. 3. FIG. 4 illustrates that the main memory 400 may further comprise a data column 400 that represents the data stored at the different main memory index addresses shown in index column 304. The primary cache 402 may be substantially similar to the primary cache 302 as described in FIG. 3, except that the primary cache 402 may comprise an additional tag column 406 and data column 408. The tag column 406 may indicate the main memory index address that stores the same data found within data column 408. FIG. 4 illustrates the current mapping of the main memory 400 to the primary cache 402 via the arrows. As shown in FIG. 4, the data stored at main memory index address 0-3 may be found within the data column 408 for index 0-way 0, index 0-way 1, index 1-way 0, and index 1-way 1 of the primary cache 402, respectively. As such, the tag columns 406 and data columns 408 for index 0-way 0, index 0-way 1, index 1-way 0, and index 1-way 1 may correspond to the index column 304 and data column 404 of the main memory index address 0-3, respectively.

Cache parameters for the overflow cache, such as the mapping of addresses to main memory, capacity, and cache replacement policies may be flexibility adjusted depending on the overflow cache performance and “miss” rate of the primary cache. Similar to primary cache 402, overflow cache may be configured to map to main memory 400 as fully associative, set associative, or as a directly mapped cache, which are discussed above. The mapping associativity for the overflow cache may be the same or differ from the primary cache 402. For example, the primary cache 402 and the overflow cache may both be a four-way associative cache and have a 1:1 ratio as the number of “way” associative. Other embodiments of the primary cache 402 may be a M-way associative cache, while the overflow cache is a N-way associative cache, where the value of M differs from the value of N. Moreover, the capacity of the overflow cache may be adjusted and may not be a fixed size. For example, the overflow cache may initially have a capacity of about eight kilobytes (KB). The capacity of the overflow cache may be increased to 32 KB when the “miss” rate is too high for the primary cache. The capacity of the primary cache may also be the same or differ from the capacity of the overflow cache.

A variety of cache replacement policies, such as Belady's algorithm, least recently used (LRU), most recently used (MRU), random replacement, and first-in-first-out (FIFO), may be used to determine which cache entry (e.g. cache line) is evicted from an overflow cache and/or primary cache 402. The overflow cache may also be configured with cache replacement policies that differ from the primary cache 402. For example, the overflow cache may be configured with the random replacement cache replacement policy, while the primary cache 402 may be configured with a LRU cache replacement policy. The cache replacement policy for the overflow cache may be adjusted to minimize the “miss” rate for the primary cache 402 and overflow cache.

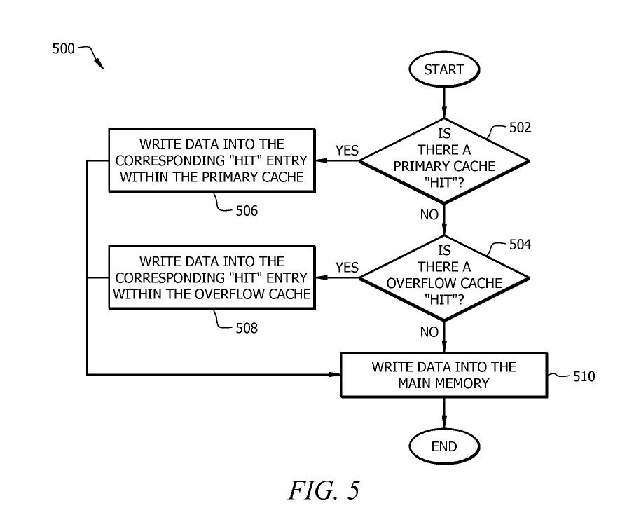

FIG. 5 is a flowchart of an embodiment of a method 500 to implement a write instruction to main memory using a write-through policy. Method 500 may be used when the writing of data is done synchronously to the main memory, the primary cache, and/or the overflow cache. Method 500 may initially receive instructions to write data to certain main memory location. After receiving the write instruction, method 500 starts at block 502 and determines if there is a primary cache “hit.” If a primary cache “hit” occurs, then method 500 moves to block 506 and writes the data into the corresponding “hit” entry within the primary cache. Afterwards, method 500 continues to block 510 to write data into the main memory. However, if method 500 determines that a primary cache “hit” does not occur at block 502, then method proceeds to block 504. At block 504, method 500 determines if there is an overflow cache “hit.” If an overflow cache “hit” occurs, then method 500 continues to block 508 and writes data into the corresponding “hit” entry within the overflow cache. In one embodiment, method 500 may promote the corresponding “hit” entry within the overflow cache to the primary cache after one or more “hits” occurred in certain time interval. In another embodiment, method 500 may not promote the corresponding “hit” entry within the overflow cache to the primary cache. Once method 500 completes block 508, method 500 may move to block 510 to write data into the main memory. Returning back to block 504, when method 500 determines at block 504 that the overflow cache “hit” does not occur, then method 500 proceeds to block 510 to write data into the main memory. After method 500 completes block 510, method 500 ends. Method 500 may complete block 502 and block 504 in parallel (e.g. within the same computing logic unit clock cycle).

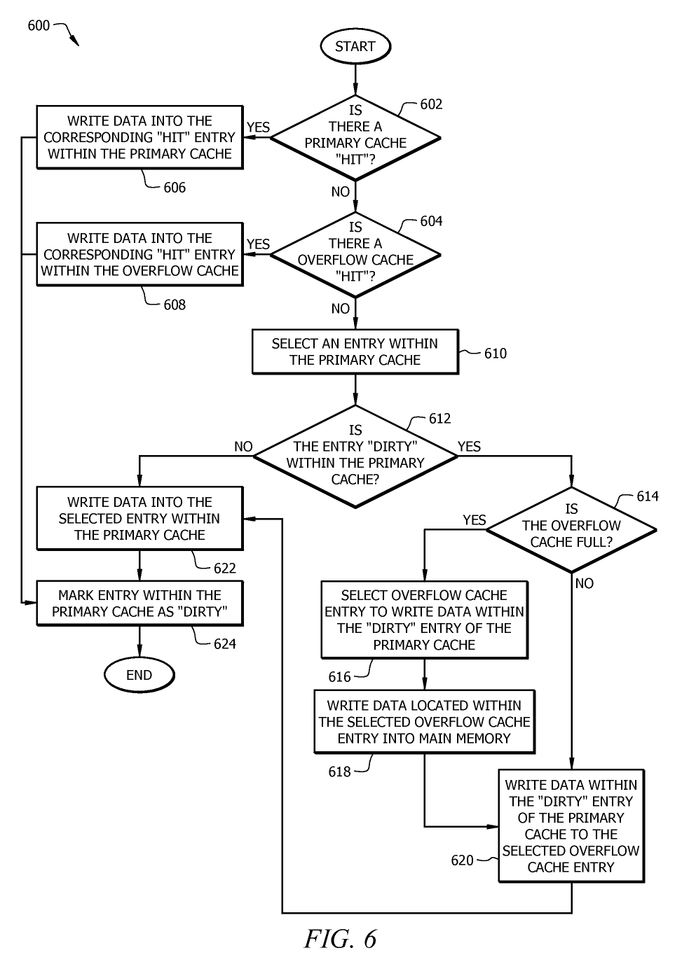

FIG. 6 is a flowchart of an embodiment of a method 600 to implement a write instruction to main memory using a write-back policy. For a write-back policy, data is initially written to the primary cache and not to main memory. The write to the main memory is postponed until the overflow cache entries containing the data are about to be modified/replaced by data evicted from the primary cache. The primary cache entries may be marked as “dirty,” so that the data may be written into the main memory after being evicted from the overflow cache. A write to an entry within the overflow cache may occur when the evicted data within the primary cache is marked as “dirty.”

Method 600 may start at block 602. Blocks 602, 604, 606, and 608 may be substantially similar to blocks 502, 504, 506, and 508 of method 500. Moreover, blocks 602 and 604 may be performed in parallel by method 600, similar to blocks 502 and 504 for method 500. At block 610, method 600 may select an entry (e.g. a cache line) within the primary cache to write data. In contrast to the write-through policy, an entry within the primary cache may be selected because the write-back policy initially writes into the primary cache and not to the main memory. Method 600 may use any of the cache replacement policies (e.g. FIFO) well known in the art at block 610. Method 600 then moves to block 612 and determines if the entry is “dirty” within the primary cache. If the entry is “dirty” (e.g. data has not be written into the main memory), then the method 600 may move to block 614. Conversely, if the entry is not “dirty”, the method 600 moves to block 622. At block 622, method 600 writes data into the selected entry within the primary cache. Afterwards, method 600 may proceed to block 624 to mark the entry within the primary cache as “dirty,” and subsequently ends.

Returning to block 614, method 600 determines if the overflow cache is full. The overflow cache is full when all of the allocated overflow cache entries for the “dirty” entry within the primary cache already stores data. For example, for a N-way set associate overflow cache, an overflow cache is full when all N overflow cache locations allocated for the “dirty” entry within the primary cache already store data. If the overflow cache is full, then method 600 moves to block 616 and selects an overflow cache entry to write data within the “dirty” entry of the primary cache. As discussed above, method 600 may use any cache replacement policy that is well known in art when selecting the overflow cache entry. Subsequently, method 600 moves to block 618 and writes the data located within the selected overflow cache entry into main memory. Method 600 then moves to block 620. Returning back to block 614, when the overflow cache is not full, then method 600 continues to block 620. At block 620, method 600 writes the data within the “dirty” entry of the primary cache into the selected overflow cache entry. After method 600 completes block 620, method 600 moves to block 610 and performs the block functions as described above.

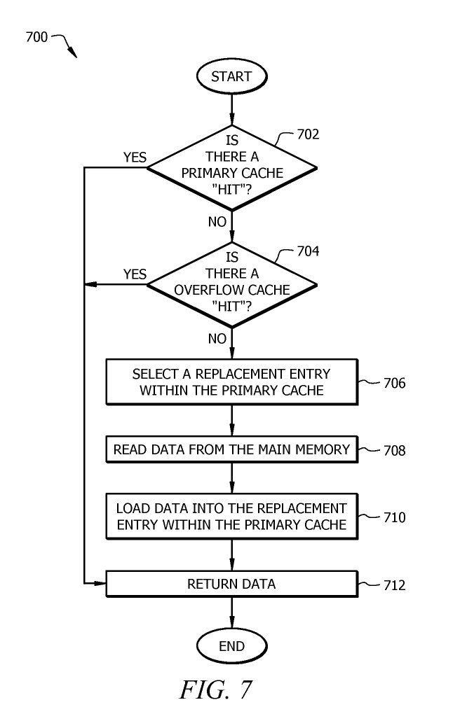

FIG. 7 is a flowchart of an embodiment of a method 700 to implement a read instruction to main memory using a write-through policy. When a “hit” occurs in the primary cache and/or the overflow cache, method 700 may use the “hit” entry from the primary cache and/or the overflow cache to return data requested by the core logic unit or other application. Method 700 may load the data from main memory into the primary cache when “misses” occurs in the primary cache and/or overflow cache. Blocks 702 and 704 may be substantially similar blocks 502 and 504 of method 500, respectively. Moreover, method 700 may perform blocks 702 and 704 in parallel (e.g. within the same clock cycle).

At block 704, if method 700 determines that there is not overflow cache “hit,” method 700 may move to block 706 to select a replacement entry within the primary cache. Method 700 may perform any cache replacement policies well known in the art. Afterwards, method 700 may proceed to block 708 and read the data from the main memory. Method 700 reads the data from the main memory because no “hits” occurred within the primary cache and overflow cache. Method 700 may then continue to block 710 and load data read from main memory into the replacement entry within the primary cache. Method 700 loads the data read from main memory because “misses” occurred within the primary cache and/or the overflow cache. At block 710, method 700 may evict data already stored in the primary cache when loading data read from the main memory. Afterwards, method 700 may proceed to block 712, and return the data to a core logic unit (e.g. a processor).

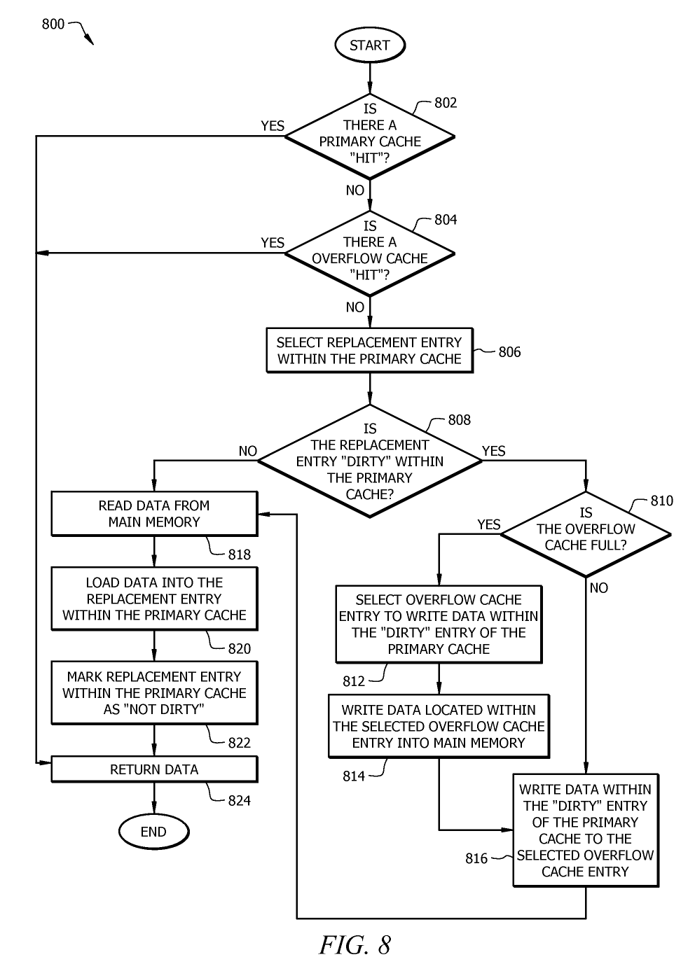

FIG. 8 is a flowchart of an embodiment of a method 800 to implement a read instruction to main memory using a write-back policy. A “miss” caused by a read instruction in a write-back policy for the primary cache and/or overflow cache may cause a cache entry to be replaced with requested “missed” data. The read “miss” may cause two main memory accesses: one to write the replaced data from the overflow cache to the main memory, and then one to retrieve the requested “missed” data from the main memory. Blocks 802, 804, 806, 818, 820, and 824 are substantially similar to blocks 702, 704, 706, 708, 710, and 712 of method 700, respectively. Moreover, blocks 810, 812, 814, and 816 are substantially similar to blocks 614, 616, 618, and 620 of method 600, respectively. At block 822, method 800 may mark the replacement entry within the primary cache as “not dirty” because the data within the replacement entry was obtained from the main memory.

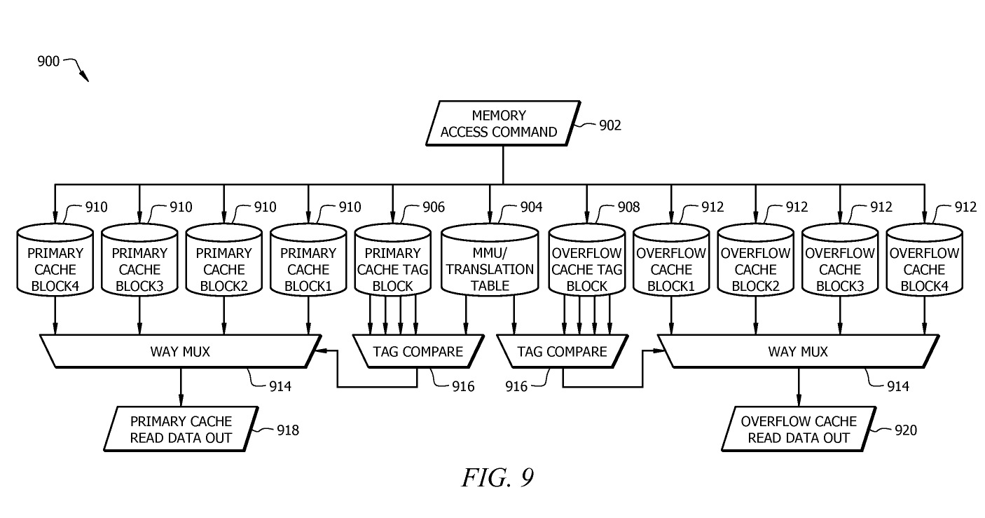

FIG. 9 is a schematic diagram of embodiment of a memory subsystem 900 that comprises a primary cache and overflow cache that share a MMU/translation table 904. The memory subsystem 900 may comprises a primary cache, overflow cache, MMU/translation table 904, a primary cache tag block 906, and an overflow cache tag block 908. FIG. 9 illustrates that the primary cache and the overflow cache may be divided into four different blocks (e.g., primary cache blocks 1-4 910 and overflow cache blocks 1-4 912) to form a four-way set associative primary cache and a four-way set associative overflow cache. The primary cache blocks 1-4 910 and overflow cache blocks 1-4 912 may be data cache blocks that stores the actual data fetched from the main memory. Using FIG. 4 as an example, the data within data column 408 may represent the data stored in the primary cache blocks 1-4 910 and overflow cache blocks 1-4 912. As discussed above, other embodiments of the primary cache may be configured as M-way set associative primary cache, while the overflow cache may have a N-way set associative overflow cache, where the “M” and “N” values may be different. When the primary cache is configured as a M-way set associative primary cache and the overflow cache is configured as a N-way set associative overflow cache, the primary cache may be divided into M different primary cache blocks 910, while the overflow cache may be divided into N different overflow cache blocks 912.

Additionally, the capacity of the primary cache and the overflow cache may vary amongst each other. For example, in one embodiment, the capacity of the primary cache and the overflow cache may be a 1:1 ratio, such as a 32 KB capacity for both the primary cache and the overflow cache. In this instance, each primary cache block 1-4 910 and each overflow cache block 1-4 912 may have a capacity of 8 KB (32 KB/4 blocks). In another embodiment, the capacity of the primary cache the overflow cache may be an 1:4 ratio, such as having a 32 KB capacity for the primary cache and an 8 KB capacity for the overflow cache. For this configuration, each primary cache block 1-4 910 may have a capacity of 8 KB (32 KB/4 blocks), and each overflow cache block 1-4 912 may have a capacity of 2 KB (8 KB/4 blocks).

The MMU/translation table 904 may be configured to translate virtual addresses to physical addresses or vice versa. The MMU/translation table 904 may be configured to translate virtual addresses to physical addresses when the primary cache blocks 910 and the overflow cache blocks 912 are configured to store physical addresses. The MMU/translation table 404 may comprise an address translation table that includes entries that map the virtual addresses to physical addresses. The MMU/translation table 904 may be further configured to maintain page information, perform permission tracking, and implement memory protection. As shown in FIG. 9, one MMU/translation table 904 may be shared amongst the primary cache and the overflow cache. Sharing a single MMU/translation table 904 and accessing the overflow cache in parallel with the primary cache may reduce the latency and improve the performance of the core logic unit. In one embodiment, the MMU/translation table 904 may be a memory protection unit (MPU) that implements memory protection, but does not translate virtual addresses to physical addresses or vice versa.

The primary cache tag block 906 may reference the main memory address for the data stored within each of the primary cache blocks 910. As such, the primary cache tag block 906 may provide four different tag addresses for each of the primary cache block 910. Using FIG. 4 as an example, the tag addresses within tag column 406 may represent the same type of tag addresses stored within the primary cache tag block 906. The four arrows depicted underneath the primary cache tag block 906 may represent the four different tag addresses for each of the primary cache blocks 1-4 910. For example, the primary cache block 1 910 may have a tag address of “0” stored within the primary cache tag block 906 and the primary cache block 2 910 may have a tag address of “1” stored within the primary cache tag block 906. The overflow cache tag block 908 may be substantially similar to the primary cache tag block 906, except that overflow cache tag block 908 may reference the main memory addresses for the data stored within each of the overflow cache blocks 912. FIG. 9 also depicts four arrows underneath the overflow cache tag block 908. Each arrow represents a different tag address that is associated with a corresponding overflow cache tag blocks 1-4 912. The tag addresses stored within the primary cache tag block 906 and the overflow cache tag block 908 may be physical or virtual memory addresses. When the MMU/translation table 904 converts a virtual memory address to a physical memory address, the primary cache tag block 906 and overflow cache tag block 908 may store physical memory addresses.

FIG. 9 illustrates that the memory subsystem 900 may receive a memory access command 902, such as an instruction to load/read data from a main memory address, from a core logic unit. When the memory subsystem 900 receives a memory access command 902, the memory access command 902 may provide a main memory address to the MMU/translation table 904, the overflow cache tag block 908, the primary cache tag block 906, the primary cache block 1-4 910, and the overflow cache block 1-4 912. In one embodiment, the main memory address may be a virtual memory address generated by a program and/or application. The MMU/translation table 904 may translate a virtual memory address to a physical memory address and feed the physical memory address to the tag compare components 916. Persons of ordinary skill in the art are aware that a core logic unit may pipeline a plurality of different types of instructions, such as an instruction fetch, instruction decode, and the memory access command 902.

The primary cache tag block 906 and the overflow cache tag block 908 may provide the tag addresses selected using the memory access command 902 and feed the tag addresses into the tag compare components 916. The tag compare components 916 may be additional computational logic that compares the inputted tag addresses with the translated physical memory address to determine whether a match occurs and output a value to the “way” mux 914. For example, if at least one of the tag addresses matches the translated physical memory address, the tag compare component 916 may output a value that selects the corresponding primary cache block 910 and/or the overflow cache block 912. Otherwise, the tag compare component 916 may generate a “null” value (e.g. a value of “0”) that may not select any of the data provided by the primary cache block 910 and/or the overflow cache block 912 to the “way” mux 914.

The primary cache blocks 1-4 910 and the overflow cache blocks 1-4 912 may use the memory access command 902 to select the relevant cache entries, and output the data within the cache entries to the “way” mux 914. The “way” mux 914 may receive the input from the tag compare components 916 and determine whether to select any one of the data input from the primary cache block 1-4 910 or from the overflow cache block 1-4 912. One “way” mux 914 may determine whether the primary cache stores the data requested in the memory access command 902, while the second “way” mux 914 may determine whether the overflow cache stores the data requested in the memory access command 902. When one of the primary cache blocks 910 stores the data requested in memory access commend 902, the “way” mux 914 may generate a primary cache read data out 918 that corresponds to a “hit” in the primary cache. When one of the overflow cache blocks 912 stores the data requested in the memory access command 902, the other “way” mux 914 may generate an overflow cache read data out 920 that corresponds to a “hit” in the overflow cache. A “miss” occurs within the primary cache and/or the overflow cache when there is no primary cache read data out 918 and/or no overflow cache read data out 920.

The main memory address within the memory access command 902 may be split such the overflow cache tag block 908 and the primary cache tag block 906 pertain to the most significant bits, while the primary cache blocks 910 and overflow cache blocks 912 pertain to the least significant bits. For example, if the main memory has a capacity of 4 gigabytes (GB), 32 bits may be used to represent the different main memory addresses (e.g. 2̂32=4,294,967,296). If each of the primary cache blocks 910 has a capacity of 8 KB (e.g. total capacity of primary cache equals 32 KB), then the lower 13 bits may be used to reference the memory address spaces for the primary cache blocks 910 (e.g. 2̂13=8192). For example, if the lower 13 bits of the main memory address is “0000000000000,” the “0000000000000” may reference the first address space within each of the primary cache blocks 910. The upper 19 bits may then be used to reference the memory address spaces for the primary cache tag block 910. In another embodiment, the primary cache and victim may split the main memory address such the most significant bits (MSBs) are designated for the tag address, the middle bits are designated for the data blocks and the least significant bits (LSBs) may be reserved for flag bits, such as designating whether a cache entry is “dirty.” Persons of ordinary skill in the art are aware that other cache entry structures may be used that split the main memory addresses differently from described above.

It is understood that by programming and/or loading executable instructions onto the general-purpose computer system 100, at least one of the core logic units 102, the memory subsystem 118, and the secondary storage 109 are changed, transforming the computer system 500 in part into a particular machine or apparatus, e.g., a network node, having the novel functionality taught by the present disclosure. It is fundamental to the electrical engineering and software engineering arts that functionality can be implemented by loading executable software into a computer, which can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus for concurrently accessing a primary cache and an overflow cache, comprising:
a core logic unit configured to:
perform a first instruction that accesses the primary cache and the overflow cache in parallel;
determine whether the primary cache stores a requested data;
determine whether the overflow cache stores the requested data; and
access a main memory when the primary cache and the overflow cache do not store the requested data,
wherein the overflow cache stores data that overflows from the primary cache.

2. The apparatus of claim 1, wherein a primary cache entry is selected using a first cache replacement policy when the primary cache and the overflow cache do not store the requested data, and wherein an evicted data stored in the primary cache entry is sent to the overflow cache to be stored.

3. The apparatus of claim 2, wherein the core logic unit is further configured to obtain the requested data from the main memory, and wherein the requested data obtained from the main memory is stored in the primary cache entry.

4. The apparatus of claim 2, wherein an overflow cache entry is selected using a second cache replacement policy to store the evicted data.

5. The apparatus of claim 4, wherein an old data stored within the overflow cache entry is written into the main memory when the primary cache entry is marked dirty.

6. The apparatus of claim 1, wherein the primary cache is configured to a M-way set associativity, wherein the overflow cache is configured to a N-way set associativity, and wherein the M-way set associativity is different from the N-way set associativity.

7. The apparatus of claim 1, wherein the requested data is promoted to the primary cache when the overflow cache stores the requested data.

8. The apparatus of claim 1, wherein the requested data for the first instruction is stored in the overflow cache, wherein the core logic unit is further configured to perform a second instruction that accesses the primary cache and the overflow cache in parallel, wherein the second instruction requests the same requested data for the first instruction, and wherein the requested data is promoted to the primary cache after the second instruction.

9. The apparatus of claim 1, wherein the requested data is not promoted to the primary cache when the overflow cache stores the requested data.

10. The apparatus of claim 1, wherein accessing the primary cache and the overflow cache in parallel comprises accessing the primary cache and the overflow cache within a same clock cycle.

11. The apparatus of claim 1, wherein the primary cache and the overflow cache have a same memory capacity.

12. An apparatus for concurrently accessing a primary cache and an overflow cache, comprising:
a primary cache that is divided into a plurality of primary cache blocks;
an overflow cache that is divided into a plurality of overflow cache blocks; and
a memory management unit (MMU) configured to perform memory management for the primary cache and the overflow cache,
wherein the primary cache and the overflow cache are accessed within a same clock cycle.

13. The apparatus of claim 12, wherein the apparatus further comprises a primary cache tag block and an overflow cache tag block, wherein the primary cache tag block is configured to store a plurality of first main memory addresses that corresponds to data stored within the primary cache blocks, and wherein the overflow cache tag block is configured to store a plurality of second main memory addresses that corresponds to data stored within the primary cache blocks.

14. The apparatus of claim 13, wherein the MMU is further configured to receive a memory access command that comprises a main memory address, and translate the main memory address to a decoded main memory address, and wherein the decoded main memory address is used to determine whether the primary cache and the overflow cache store data corresponding to the decoded main memory address.

15. The apparatus of claim 14, wherein the decoded main memory address is compared to one of the first main memory addresses, and wherein the decoded main memory address is compared to one of the second main memory addresses.

16. The apparatus of claim 12, wherein the MMU is configured to translate a virtual memory address to a physical memory address.

17. A method for concurrently accessing a primary cache and an overflow cache, wherein the method comprises:
determining whether a primary cache miss has occurred within a primary cache;
determining whether an overflow cache miss has occurred within an overflow cache;
selecting a primary cache entry using a first cache replacement policy when a primary cache miss has occurred within a primary cache; and
selecting an overflow cache entry using a second cache replacement policy when an overflow cache miss has occurred within an overflow cache,
wherein determining whether the primary cache miss and the overflow cache miss occurs within a same clock cycle.

18. The method of claim 17 further comprising modifying the second cache replacement policy to select overflow cache entries, wherein the first cache replacement policy and the second cache replacement policy are different.

19. The method of claim 17, wherein the overflow cache has a first memory capacity, and wherein the method further comprises modifying the first memory capacity of the overflow cache.

20. The method of claim 17, wherein the overflow cache has a number of set associativity with a main memory, and wherein the method further comprises modifying the number of set associativity with the main memory.
